(19) United States
(12) Patent Application Publication
(10) Pub. No.: US 2025/0100878 A1
(43) Pub. Date: Mar. 27, 2025

(54) METHOD OF REGENERATING SODIUM BOROHYDRIDE

(71) Applicants: HYUNDAI MOTOR COMPANY, Seoul (KR); KIA CORPORATION, Seoul (KR); KOREA INSTITUTE OF SCIENCE AND TECHNOLOGY, Seoul (KR)

(72) Inventors: Jihui Seo, Ulsan (KR); Jaeyong Lee, Seongnam-si (KR); Jihye Park, Seoul (KR); Ji-Hoon Jang, Suwon-si (KR); Pyung Soon Kim, Suwon-si (KR); Hanjin Kim, Seoul (KR); Hyangsoo Jeong, Seoul (KR); Hyuntae Sohn, Seoul (KR); Jaewon Kirk, Seoul (KR); Yoondo Kim, Seoul (KR); Yongmin Kim, Seoul (KR); Suk Woo Nam, Seoul (KR)

(73) Assignees: HYUNDAI MOTOR COMPANY, Seoul (KR); KIA CORPORATION, Seoul (KR); KOREA INSTITUTE OF SCIENCE AND TECHNOLOGY, Seoul (KR)

(21) Appl. No.: 18/403,314

(22) Filed: Jan. 3, 2024

(30) Foreign Application Priority Data
Sep. 22, 2023 (KR) 10-2023-0127014

(51) Int. Cl. C01B 6/21

(52) U.S. Cl. CPC C01B 6/21

(57) ABSTRACT

A method of regenerating sodium borohydride includes: pretreating reactants including sodium tetraborate hydrate (Na₂B₄O₇·xH₂O, 0<x≤10), a metal salt, and a reducing agent; and reacting the pretreated reactants by a ball-milling method, wherein the metal salt includes NaHCO₂, KHCO₂, LiHCO₂, NaHCO₃, Na₂CO₃, NaOH, KHCO₃, K₂CO₃, LiHCO₃, Li₂CO₃, Na₂O₂, NaH, or a combination thereof.

### CROSS-REFERENCE TO RELATED APPLICATION

This application claims priority to and the benefit of Korean Patent Application No. 10-2023-0127014 filed in the Korean Intellectual Property Office on Sep. 22, 2023, the entire contents of which are incorporated herein by reference.

### BACKGROUND

### (a) Field

A method of regenerating sodium borohydride is disclosed.

### (b) Description of the Related Art

In order to use sodium borohydride (SBH) as a hydrogen storage material for hydrogen extraction, regeneration as well as production is essential.

A conventional SBH regeneration method requires harsh conditions of a high pressure and a high temperature in order to reduce a boron complex, a product of a hydrolysis reaction of sodium borohydride.

Recently, a ball-milling method has been proposed to alleviate these harsh conditions. However, this method uses a very expensive material such as sodium hydride (NaH) for the reduction and has a limitation of a low yield.

The statements in this section merely provide background information related to the present disclosure and may not constitute prior art.

### SUMMARY

An embodiment provides a method for regenerating sodium borohydride (NaBH₄), which enables a cost of sodium borohydride to be reduced, has a high regeneration yield, and increases a convenience of regeneration.

According to an embodiment, a method of regenerating sodium borohydride includes pretreating reactants including sodium tetraborate hydrate (Na₂B₄O₇·xH₂O, 0<x≤10), a metal salt, and a reducing agent; and reacting the pretreated reactants by a ball-milling method, wherein the metal salt includes sodium formate (NaHCO₂), potassium formate (KHCO₂), lithium formate (LiHCO₂), sodium bicarbonate (NaHCO₃), sodium carbonate (Na₂CO₃), sodium hydroxide (NaOH), potassium bicarbonate (KHCO₃), potassium carbonate (K₂CO₃), lithium bicarbonate (LiHCO₃), lithium carbonate (Li₂CO₃), sodium peroxide (Na₂O₂), sodium hydride (NaH), or a combination thereof.

The sodium tetraborate hydrate may be a product of a hydrolysis reaction of sodium borohydride (NaBH₄).

The metal salt may include NaHCO₂ and the NaHCO₂ may be a product of a hydrolysis reaction of sodium borohydride (NaBH₄).

The hydrolysis reaction of sodium borohydride (NaBH₄) may be performed under an acid catalyst.

The reducing agent may include a metal of magnesium (Mg), silicon (Si), aluminum (Al), sodium aluminum hydride (NaAlH₄), an Mg-containing alloy, or a combination thereof.

The reactants may include the sodium tetraborate hydrate, the metal salt, and the reducing agent in a mole ratio in a range of 1:0.5:10 to 1:4:40.

In the reactants, a mole ratio of the metal salt to the sodium tetraborate hydrate may be in a range of 0.5:1 to 4:1. Additionally, in the reactants, a mole ratio of the reducing agent to sodium tetraborate hydrate may be in a range of 10:1 to 40:1.

The pretreating may include a dehydration process.

The dehydration process may be performed at a temperature in a range of 0° C. to 300° C. and a pressure in a range of 0.01 atm to 3 atm.

The dehydration process may be performed in a gas atmosphere of argon (Ar), nitrogen (N₂), air, hydrogen (H₂), or a combination thereof.

The ball-milling method may be performed at a speed in a range of 450 rpm to 1200 rpm for 2 hours to 36 hours.

The ball-milling method may be performed at an initial H₂ pressure in a range of 5 bar to 70 bar.

The sodium borohydride may be used to extract hydrogen through a hydrolysis reaction.

A regeneration yield of sodium borohydride by the regeneration method may be 50% or more.

The method for regenerating sodium borohydride according to an embodiment enables lowering a cost of sodium borohydride, increases the regeneration yield, and increases a convenience of regeneration. Accordingly, sodium borohydride can be usefully used for hydrogen extraction through a hydrolysis reaction.

### BRIEF DESCRIPTION OF THE DRAWINGS

FIG. 1 is a graph showing an analysis result of a product of the hydrolysis reaction of sodium borohydride, used as a reactant in the method for regenerating sodium borohydride according to Example 2, using an X-ray diffraction (XRD) method.

FIG. 2 is a graph showing an analysis result of the product of the hydrolysis reaction of sodium borohydride, which was used as a reactant in the method for regenerating sodium borohydride according to Example 2, using Fourier transform infrared spectroscopy (FT-IR).

FIG. 3 is a graph showing an analysis result of the product of the hydrolysis reaction of sodium borohydride, which is used as a reactant in the method for regenerating sodium borohydride according to Example 2, using 13C NMR.

FIG. 4 is a graph showing the regeneration yield of sodium borohydride according to the regeneration methods of sodium borohydride in Examples 1 and 2 and Comparative Examples 1 to 4.

### DETAILED DESCRIPTION

The advantages, features, and aspects to be described hereinafter become apparent from the following description of the embodiments with reference to the accompanying drawings, which is set forth hereinafter. However, the embodiments should not be construed as being limited to the embodiments set forth herein. Although not specifically defined, all of the terms including the technical and scientific terms used herein have meanings understood by ordinary persons skilled in the art. The terms defined in a generally-used dictionary may not be interpreted ideally or exaggeratedly unless clearly defined. In addition, unless explicitly described to the contrary, the word “comprise,” and variations such as “comprises” or “comprising”, are understood to imply the inclusion of stated elements but not the exclusion of any other elements.

Further, the singular includes the plural unless mentioned otherwise.

An embodiment provides a method for regenerating sodium borohydride.

The sodium borohydride (NaBH₄) is used for hydrogen extraction through a hydrolysis reaction, and regeneration using the products of the hydrolysis reaction is very important for the practical use of hydrogen extraction technology.

The hydrolysis reaction for hydrogen extraction using sodium borohydride is, for example, as shown in Reaction Scheme 1.

NaBH₄+0.5HCOOH+(3.5)H₂O→0.5NaHCO₂+0.25(Na₂B₄O₇·5H₂O)+4H₂+0.5H₂O [Reaction Scheme 1]

Referring to Reaction Scheme 1, the hydrolysis reaction of sodium borohydride using an acid catalyst may have, for example, a product of sodium tetraborate pentahydrate and NaHCO₂. Reaction Scheme 1 shows only an example of the product of the hydrolysis reaction of sodium borohydride by using an acid catalyst, but the product of the hydrolysis reaction of sodium borohydride according to an embodiment is not limited to that of Reaction Scheme 1.

The acid catalyst may include formic acid but is not limited thereto.

An embodiment provides a method of regenerating sodium borohydride using the product of the hydrolysis reaction of sodium borohydride, specifically, the product of the hydrolysis reaction of sodium borohydride using an acid catalyst.

A method of regenerating sodium borohydride according to an embodiment includes pretreating reactants including sodium tetraborate hydrate (Na₂B₄O₇·xH₂O, 0<x≤10), a metal salt, and a reducing agent. The method further includes reacting the pretreated reactants by a ball-milling method. In certain examples, the metal salt may include sodium formate (NaHCO₂), potassium formate (KHCO₂), lithium formate (LiHCO₂), sodium bicarbonate (NaHCO₃), sodium carbonate (Na₂CO₃), sodium hydroxide (NaOH), potassium bicarbonate (KHCO₃), potassium carbonate (K₂CO₃), lithium bicarbonate (LiHCO₃), lithium carbonate (Li₂CO₃), sodium peroxide (Na₂O₂), sodium hydride (NaH), or a combination thereof.

Using this method of regenerating sodium borohydride, it is advantageously possible to reduce a cost of sodium borohydride, increase a regeneration yield, and increase a convenience of regeneration. Because this sodium borohydride can be usefully used for hydrogen extraction through a hydrolysis reaction, it can contribute to the development of hydrogen extraction technology or hydrogen storage technology using sodium borohydride.

Specifically, the metal salt may include NaHCO₂, KHCO₂, LiHCO₂, NaHCO₃, Na₂CO₃, NaOH, KHCO₃, K₂CO₃, LiHCO₃, Li₂CO₃, Na₂O₂, NaH, or a combination thereof. Among these metal salts, in certain examples, NaHCO₂, Na₂CO₃, NaOH, Na₂O₂, NaH, or a combination thereof may be used. In one particular example, NaHCO₂ may be used.

The metal salt may be added as an additive to react with sodium tetraborate hydrate or a product of a hydrolysis reaction of sodium borohydride. Alternatively, in certain examples, because the metal salt, (e.g., NaHCO₂) is also the product of a hydrolysis reaction of sodium borohydride for hydrogen extraction, the product of the hydrolysis reaction can be directly used for regeneration without adding a separate additive.

According to an embodiment, an inexpensive material such as NaHCO₂ or the like is used instead of an expensive material such as NaH to regenerate sodium borohydride, resulting in reducing a price of the sodium borohydride. In addition, when the metal salt of the inexpensive material such as NaHCO₂ or the like is used, a high regeneration yield also may be secured through a simple pretreatment before reacting the reactant. Furthermore, even when the product of a hydrolysis reaction of sodium borohydride is directly used to regenerate sodium borohydride, because a very high regeneration yield is secured through the pretreatment, the regeneration may be more conveniently achieved without separately separating and purifying a compound.

The reducing agent may include metals such as Mg, Si, Al, NaAlH₄, an Mg-containing alloy, or a combination thereof.

The reactant may include the sodium tetraborate hydrate, the metal salt, and the reducing agent in a mole ratio in a range of 1:0.5:10 to 1:4:40, or in a range of 1:1:20 to 1:3:30. When the reactant has a composition ratio within the ranges, a high regeneration yield may be secured.

The metal salt to the sodium tetraborate hydrate may have a mole ratio in a range of 0.5:1 to 4:1, in a range of 1:1 to 3:1, or in a range of 2:1 to 3:1. In addition, the reducing agent to the sodium tetraborate hydrate may have a mole ratio in a range of 10:1 to 40:1, in a range of 20:1 to 30:1, or in a range of 20:1 to 27:1. When two components of the reactant have each mole ratio within the ranges, a high regeneration yield may be secured.

The pretreatment of the reactant may include a dehydration process. The dehydration process is a process of dehydrating the reactant and specifically, the sodium tetraborate hydrate.

When the pretreatment is performed before a reaction in the ball mill method, even though the inexpensive material is used as the metal salt, a high regeneration yield may be secured. In addition, when the product after the hydrolysis reaction of sodium borohydride is directly used as the metal salt for regeneration reaction, a very high regeneration yield may be secured through this pretreatment.

The dehydration process may be performed specifically at a temperature in a range of 0° C. to 300° C. or in a range of 100° C. to 200° C. under a pressure in a range of 0.01 atm to 3 atm or in a range of 0.01 atm to 1 atm. In addition, the dehydration process may be performed under a gas atmosphere such as Ar, N₂, air, H₂, or a combination thereof. When the dehydration process is performed under the condition ranges, a high regeneration yield may be secured.

The ball-milling method is to mix balls made of zirconium dioxide (ZrO₂), iron (Fe), or the like with the reactant, that is, sodium tetraborate hydrate, a metal salt, and a reducing agent.

The ball-milling method may be performed at a rotational speed in a range of 450 rpm to 1200 rpm or in a range of 600 rpm to 1100 rpm for 2 hours to 36 hours or 4 hours to 30 hours. In addition, the method may be performed under an initial H₂ pressure in a range of 5 bars to 70 bars or in a range of 10 bars to 50 bars. When the ball-milling method is performed under the condition ranges, a high regeneration yield may be secured.

The method of regenerating sodium borohydride according to an embodiment may achieve a sodium borohydride regeneration yield of greater than or equal to 50 or greater than or equal to 60%. In addition, when the products of the hydrolysis reaction of sodium borohydride, (e.g., sodium tetraborate hydrate and a metal salt such as NaHCO₂ or the like) are directly used to regenerate sodium borohydride, a regeneration yield of greater than or equal to 70% may be achieved. Accordingly, the product itself of the hydrolysis reaction of sodium borohydride by using an acid catalyst may be used to regenerate sodium borohydride at a high yield.

Therefore, the method of regenerating sodium borohydride according to an embodiment may reduce a price of the sodium borohydride as well as secure a high regeneration yield thereof, which may be usefully used for hydrogen extraction through the hydrolysis reaction.

Hereinafter, the embodiments are illustrated in more detail with reference to examples. However, these examples are exemplary, and the scope of claims is not limited thereto.

### Method of Regenerating Sodium Borohydride

### Example 1

NaHCO₂ (99%, Sigma Aldrich) and Mg were added to sodium tetraborate decahydrate (Na₂B₄O₇·10H₂O), which was a hydrolysis reaction product of sodium borohydride (NaBH₄) to prepare a reactant, and then, a dehydration process proceeded at 170° C. under 1 atm. Herein, the reactant was prepared by using sodium tetraborate decahydrate, NaHCO₂, and Mg in a mole ratio of 1:2:22.5.

Subsequently, the dehydrated reactant was reacted in a ball-milling method to regenerate sodium borohydride. Herein, the ball-milling method was performed at room temperature under an initial H₂ pressure of 20 bars at 450 rpm for 12 hours.

### Example 2

Mg was added to sodium tetraborate pentahydrate (Na₂B₄O₇·5H₂O) and NaHCO₂, which were two products of a hydrolysis reaction of sodium borohydride (NaBH₄) by using an acid catalyst (HCOOH) to prepare a reactant, and then, a dehydration process proceeded at 170° C. under a pressure of 1 atm. Herein, the reactant was prepared by using sodium tetraborate pentahydrate, NaHCO₂, and Mg in a mole ratio of 1:2:22.5.

Subsequently, the dehydrated reactant was reacted in a ball-milling method to regenerate sodium borohydride. Herein, the ball-milling method was performed at room temperature under an initial H₂ pressure of 20 bars at 450 rpm for 12 hours.

### Comparative Example 1

NaH and Mg were added to sodium tetraborate decahydrate (Na₂B₄O₇·10H₂O), which was a product of a hydrolysis reaction of sodium borohydride (NaBH₄) to prepare a reactant. Herein, the reactant was prepared by using sodium tetraborate pentahydrate, NaH, and Mg in a mole ratio of 1:2:22.5.

Subsequently, the reactant was reacted in a ball-milling method to regenerate sodium borohydride. Herein, the ball-milling method was performed at room temperature under an initial H₂ pressure of 20 bars at 450 rpm for 12 hours.

### Comparative Example 2

Sodium borohydride was regenerated in the same manner as in Comparative Example 1 except that a dehydration process was additionally performed at 170° C. under a pressure of 1 atm before reacting the reactant of Comparative Example 1 in the ball-milling method.

### Comparative Example 3

Sodium borohydride was regenerated in the same manner as in Example 1 except that the dehydration process was omitted.

### Comparative Example 4

Sodium borohydride was regenerated in the same manner as in Example 2 except that the dehydration process was omitted.

### Evaluation 1: Product Analysis of Hydrolysis Reaction of NaBH₄

In Example 2, a product of a hydrolysis reaction of sodium borohydride (NaBH₄) by using an acid catalyst (HCOOH) was used as a reactant. Herein, the hydrolysis reaction of sodium borohydride (NaBH₄) is shown in Reaction Scheme 1.

NaBH₄+0.5HCOOH+(3.5)H₂O→0.5NaHCO₂+0.25(Na₂B₄O₇·5H₂O)+4H₂+0.5H₂O [Reaction Scheme 1]

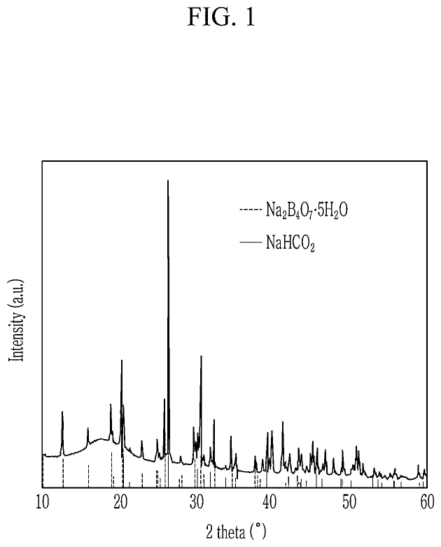

Herein, products after the hydrolysis reaction of sodium borohydride were analyzed by using X-ray diffraction (XRD), Fourier transform infrared spectroscopy (FT-IR), and ¹³C NMR, and the results are shown in FIGS. 1 to 3.

FIG. 1 is a graph showing an analysis result of a product of the hydrolysis reaction of sodium borohydride, used as a reactant in the method for regenerating sodium borohydride according to Example 2, using an X-ray diffraction (XRD) method.

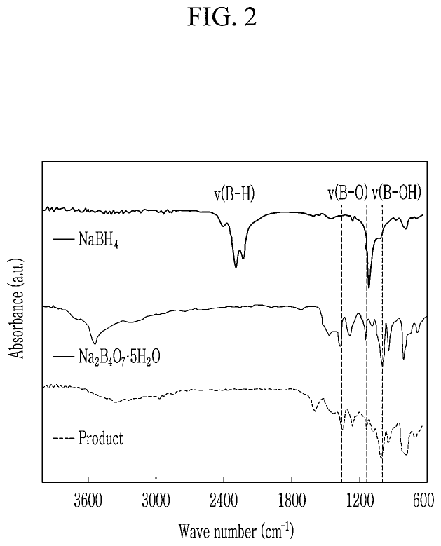

FIG. 2 is a graph showing an analysis result of the product of the hydrolysis reaction of sodium borohydride, which was used as a reactant in the method for regenerating sodium borohydride according to Example 2, using Fourier transform infrared spectroscopy (FT-IR).

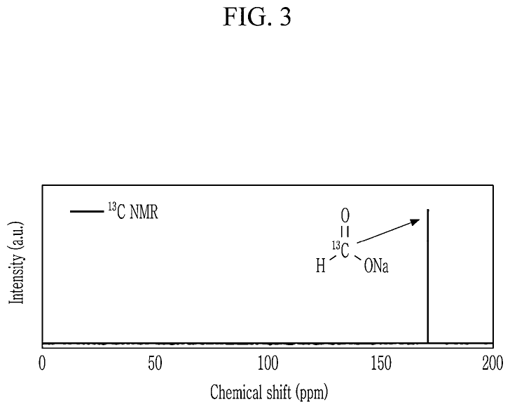

FIG. 3 is a graph showing an analysis result of the product of the hydrolysis reaction of sodium borohydride, which is used as a reactant in the method for regenerating sodium borohydride according to Example 2, using 13C NMR.

Referring to FIGS. 1 to 3, the products of the hydrolysis reaction of sodium borohydride were sodium tetraborate pentahydrate (Na₂B₄O₇·5H₂O) and NaHCO₂.

### Evaluation 2: Regeneration Yield of NaBH₄

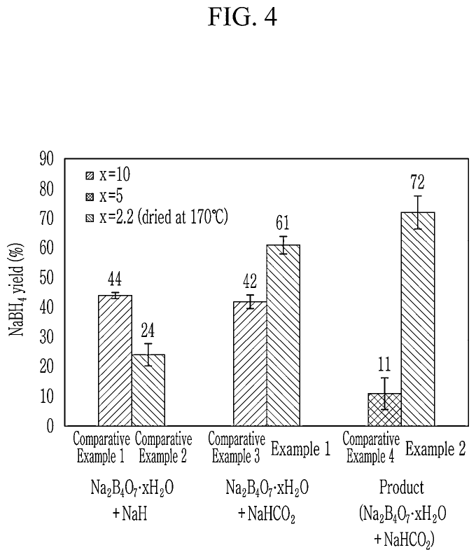

The sodium borohydrides (SBH) regenerated according to Examples 1 and 2 and Comparative Examples 1 to 4 were measured with respect to each regeneration yield, and the results are shown in FIG. 4.

When the regeneration reaction was completed, 300 mg of each of the products was collected in a glove box and dissolved in 1 ml of a 5 wt % KOH solution and 0.2 ml of D2O. The regeneration yield was obtained by measuring how much a peak-40 ppm corresponding to NaBH₄ to a borate peak was converted through 11B NMR spectroscopy.

$$SBH yield ( \% ) = \{ ( a region corresponding to SBH \text{)/(} a region corresponding to total boron ) \} \times 100$$

FIG. 4 is a graph showing the sodium borohydride regeneration yields according to the of sodium borohydride regeneration method of Examples 1 and 2 and Comparative Examples 1 to 4.

Referring to FIG. 4, Examples 1 and 2, in which NaHCO₂ as a metal salt was used, and a preheat treatment was performed, exhibited a significantly high regeneration yield of sodium borohydride, compared with Comparative Examples 1 and 2, in which expensive NaH was used, and Comparative Examples 3 and 4, in which NaHCO₂ as a metal salt was used, but the preheat treatment was not performed. Accordingly, when a metal salt such as inexpensive NaHCO₂ and the like was used as a material replacing the expensive NaH, and the preheat treatment was also performed, a high regeneration yield was secured.

In addition, compared with Example 1, in which NaHCO₂, a product of a hydrolysis reaction of sodium borohydride, was separately used as an additive, Example 2, in which NaHCO₂ was directly used, exhibited a much higher regeneration yield of sodium borohydride. Accordingly, when the product itself of a hydrolysis reaction of sodium borohydride by using an acid catalyst was used, the sodium borohydride was regenerated at a high yield.

While this disclosure has been described in connection with what is presently considered to be practical example embodiments, it is to be understood that the disclosure is not limited to the disclosed embodiments. On the contrary, the disclosure is intended to cover various modifications and equivalent arrangements included within the spirit and scope of the appended claims.

What is claimed is:

1. A method of regenerating sodium borohydride, the method comprising:
pretreating reactants comprising sodium tetraborate hydrate (Na₂B₄O₇·xH₂O, 0<x≤10), a metal salt, and a reducing agent; and
reacting the pretreated reactants by a ball-milling method to regenerate sodium borohydride,
wherein the metal salt comprises NaHCO₂, KHCO₂, LiHCO₂, NaHCO₃, Na₂CO₃, NaOH, KHCO₃, K₂CO₃, LiHCO₃, Li₂CO₃, Na₂O₂, NaH, or a combination thereof.

2. The method of claim 1, wherein the sodium tetraborate hydrate is a product of a hydrolysis reaction of sodium borohydride (NaBH₄).

3. The method of claim 2, wherein the hydrolysis reaction of the sodium borohydride (NaBH₄) is performed under an acid catalyst.

4. The method of claim 1, wherein the metal salt comprises NaHCO₂, and
wherein the NaHCO₂ is a product of a hydrolysis reaction of sodium borohydride (NaBH₄).

5. The method of claim 4, wherein the hydrolysis reaction of the sodium borohydride (NaBH₄) is performed under an acid catalyst.

6. The method of claim 1, wherein the reducing agent comprises Mg, Si, Al, NaAlH₄, an Mg-containing alloy, or a combination thereof.

7. The method of claim 1, wherein the reactants comprise the sodium tetraborate hydrate, the metal salt, and the reducing agent in a mole ratio in a range of 1:0.5:10 to 1:4:10:40.

8. The method of claim 1, wherein a mole ratio of the metal salt to the sodium tetraborate hydrate in the reactants is in a range of 0.5:1 to 4:1, and
wherein a mole ratio of the reducing agent to sodium tetraborate hydrate in the reactants is in a range of 10:1 to 40:1.

9. The method of claim 1, wherein the pretreating comprises a dehydration process.

10. The method of claim 9, wherein the dehydration process is performed at a temperature in a range of 0° C. to 300° C. and a pressure in a range of 0.01 atm to 3 atm.

11. The method of claim 9, wherein the dehydration process is performed in a gas atmosphere comprising Ar, N₂, air, H₂, or a combination thereof.

12. The method of claim 1, wherein the ball-milling method is performed at a speed in a range of 450 rpm to 1200 rpm for 2 hours to 36 hours.

13. The method of claim 1, wherein the ball-milling method is performed at an initial H₂ pressure in a range of 5 bar to 70 bar.

14. The method of claim 1, wherein the sodium borohydride is used to extract hydrogen through a hydrolysis reaction.

15. The method of claim 1, wherein a regeneration yield of the sodium borohydride is 50% or more.
